(19) United States
(12) Patent Application Publication
(10) Pub. No.: US 2026/0125112 A1
(43) Pub. Date: May 7, 2026

(54) VEHICLE UNDERFLOOR STRUCTURE

(71) Applicant: TOYOTA JIDOSHA KABUSHIKI KAISHA, Toyota-shi (JP)

(72) Inventors: Seiya ISHIKURA, Toyota-shi (JP); Naoyuki YOKOTANI, Okazaki-shi (JP)

(73) Assignee: TOYOTA JIDOSHA KABUSHIKI KAISHA, Toyota-shi (JP)

(21) Appl. No.: 19/296,378

(22) Filed: Aug. 11, 2025

(30) Foreign Application Priority Data
Nov. 6, 2024 (JP) 2024-194640

(51) Int. Cl. B62D 21/15; B60R 16/04; H01M 50/242; H01M 50/249

(52) U.S. Cl. CPC B62D 21/15; B60R 16/04; H01M 50/242; H01M 50/249; H01M 2220/20

(57) ABSTRACT

A vehicle underfloor structure includes a battery pack that is installed underfloor in a vehicle, and a share panel that is disposed on a lower side of the battery pack. The vehicle underfloor structure further includes an impact mitigation member that is made of a dilatant material and that is disposed between a lower face of the battery pack and the share panel. The impact mitigation member that is made of the dilatant material is disposed only between the lower face of the battery pack and the share panel.

### CROSS-REFERENCE TO RELATED APPLICATION

This application claims priority to Japanese Patent Application No. 2024-194640 filed on Nov. 6, 2024. The disclosure of the above-identified application, including the specification, drawings, and claims, is incorporated by reference herein in its entirety.

### BACKGROUND

### 1. Technical Field

The present disclosure relates to a vehicle underfloor structure.

### 2. Description of Related Art

In a vehicle underfloor structure that is disclosed in WO 2012/081173, a case of a battery pack has a double-layer structure. An inner layer of the case is made of a metal or resin, and an outer layer of the case is made of a dilatant material. The member that is made of the dilatant material is arranged to protect the battery pack.

### SUMMARY

An object of the present disclosure is to suppress cost increases in a vehicle underfloor structure that includes a member that is made of a dilatant material that protects a battery pack.

A vehicle underfloor structure according to a first aspect includes a battery pack that is installed underfloor in a vehicle, a share panel that is disposed on a lower side of the battery pack, and an impact mitigation member that is made of a dilatant material and that is disposed only between a lower face of the battery pack and the share panel.

In this aspect, the vehicle underfloor structure includes the battery pack that is installed underfloor in the vehicle, and the share panel that is disposed on the lower side of the battery pack.

Accordingly, the share panel can protect the battery pack from fallen objects lying on the road, speed bumps, bottoming-out roads, and the like.

However, in order to adequately protect the battery pack, there is a problem of increased weight, increased costs, and so forth, with respect to the share panel. Also, in order to adequately absorb impact energy, providing an up-down direction gap (impact absorbing stroke) between the battery pack and the share panel becomes necessary.

Accordingly, in this aspect, the vehicle underfloor structure further includes the impact mitigation member that is made of the dilatant material and that is disposed between the lower face of the battery pack and the share panel.
Thus, the impact mitigation member that is made of the dilatant material functions to protect the battery pack from underfloor impact. In particular, dilatant materials have a nature of becoming hard when subjected to a great input, and accordingly a small impact absorbing stroke is sufficient. As a result, occurrence of the above problems regarding the share panel can be suppressed.

Further, in this aspect, the impact mitigation member that is made of the dilatant material is disposed only between the lower face of the battery pack and the share panel. That is to say, the impact mitigation member is not disposed on a top face side or side face sides of the battery pack, where any possibility of contact with a fallen object or the like is low.

Accordingly, increase in costs due to providing the impact mitigation member that is made of the dilatant material can be suppressed.

With the vehicle underfloor structure according to a second aspect, in the first aspect, the share panel is made of fiber-reinforced plastic.

In this aspect, the share panel is made of fiber-reinforced plastic.

Accordingly, weight of the structure can be reduced more easily as compared to a form in which the share panel is made of iron. The share panel that is made of the fiber-reinforced plastic has high functionality of suppressing penetration by sharp foreign objects, but does not absorb impact well. However, absorption of impact can be borne by the impact mitigation member that is made of the dilatant material.

Note that in an embodiment described below, the share panel is provided with a share panel main portion and a reinforcing member, both of which are made of fiber-reinforced plastic, but the share panel of this aspect is not limited to this. It is sufficient for the share panel of this aspect to have at least the share panel main portion that is made of fiber-reinforced plastic. Also, the share panel of this aspect may be made up of just the share panel main portion.

With the vehicle underfloor structure according to a third aspect, in the first or the second aspect, the share panel includes a share panel main portion, and the impact mitigation member fills a gap between the share panel main portion and the lower face of the battery pack with no space remaining between the share panel main portion and the lower face.

In this aspect, the share panel includes the share panel main portion. The impact mitigation member fills in the gap between the share panel main portion and the lower face of the battery pack, with no space remaining therebetween.

Accordingly, the battery pack can be protected more effectively. Also, the structure can be made smaller in size in the up-down direction of the vehicle, as compared to a case in which the aforementioned gap is provided.

With the vehicle underfloor structure according to a fourth aspect, in any of the first to third aspects, the battery pack includes a lower case with a bottom plate portion, the bottom plate portion includes a bulging portion that partially bulges upward, and the impact mitigation member is partially provided corresponding with a portion of the bottom plate portion at which the bulging portion is situated.

In this aspect, the battery pack includes a lower case having a bottom plate portion, and the bottom plate portion has a bulging portion that partially bulges upward.

Accordingly, rigidity of the bottom plate portion can be improved.
Also, in this aspect, the impact mitigation member is partially provided corresponding to portions at which the bulging portions are situated in the bottom plate portion.
Accordingly, the amount of the impact mitigation member that is made of the dilatant material that is used can be reduced, while securing protection of battery pack.

With the vehicle underfloor structure according to a fifth aspect, in any one of the first to fourth aspects, the impact mitigation member is integrated with the battery pack or the share panel.

In this aspect, the impact mitigation member is integrated with the battery pack or the share panel.

Accordingly, the impact mitigation member can be handled integrally with either the battery pack or the share panel during a vehicle assembly process.

As described above, according to the present disclosure, cost increases can be suppressed regarding a vehicle underfloor structure that includes a member that is made of a dilatant material that protects a battery pack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle that has a vehicle underfloor structure according to an embodiment;

FIG. 2 is a schematic cross-sectional view illustrating a structure in an enlarged manner, in which an impact mitigation member is disposed; and

FIG. 3 is a cross-sectional view corresponding to FIG. 2 according to a modification.

### DETAILED DESCRIPTION OF EMBODIMENTS

A vehicle underfloor structure S according to an embodiment will be described below.

Note that arrow FR indicates a vehicle-forward direction, arrow UP indicates a vehicle-upward direction, and arrow LH indicates a left-hand side in a vehicle width direction, respectively, these arrows being included in the drawings as appropriate. Also, terms regarding directions of front-rear, up-down, and right-left, when used in the following description, indicate front-rear in a vehicle front-rear direction, up-down in a vehicle up-down direction, and right-left in the vehicle width direction, unless specified otherwise.

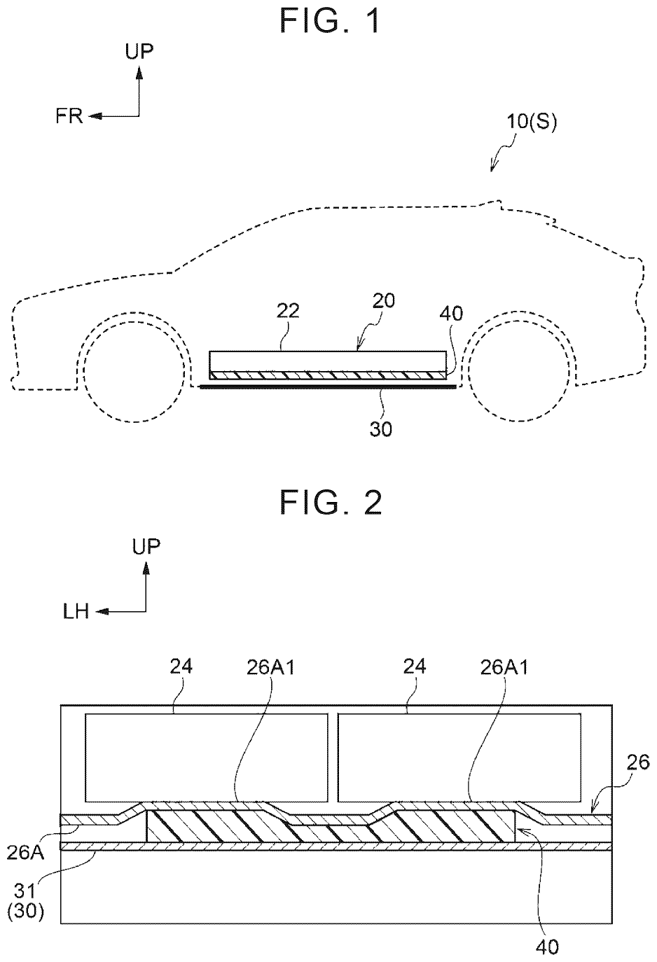

FIG. 1 is a diagram illustrating a vehicle 10 that has the vehicle underfloor structure S.

As illustrated in FIG. 1, the vehicle underfloor structure S includes a battery pack 20 that is installed underfloor in a vehicle, a share panel 30 that is disposed on a lower side of the battery pack 20, and an impact mitigation member 40 made of a dilatant material that is disposed between a lower face of the battery pack 20 and the share panel 30.

The battery pack 20 includes a battery case 22. The battery case 22 includes, for example, a lower case and an upper case. The battery case 22 houses a plurality of battery modules 24 therein.

The lower case 26 has a bottom plate portion 26A. The bottom plate portion 26A has bulging portions 26A1 that bulge partially upward and that also extend in the vehicle front-rear direction. The battery modules 24 are disposed on the bulging portions 26A1.

The impact mitigation member 40 that is made of the dilatant material is a member for absorbing and reducing impact by utilizing the dilatant effect. Dilatant nature refers to a nature of certain types of fluids or materials to instantaneously increase in viscosity and harden when subjected to a sudden external force (pressure or impact). Dilatant materials are normally soft and easily deformed, but have a property of temporarily hardening when subjected to impact. The dilatant material can be made of, for example, plastic, rubber, or resin material with fibers that are woven therein, containing an organic substance that imparts dilatant properties. The organic material that imparts the dilatant properties is in a liquid or gel state, for example. The impact mitigation member 40 that is made of a dilatant material is, for example, configured as a bag that is filled with a liquid or gel substance that imparts the dilatant properties. An example of the gel substance is thermally conductive silicone grease, and specific examples thereof include a material containing at least one type of thermally conductive material, such as aluminum, silver, copper, nickel, zinc oxide, alumina, magnesium oxide, aluminum nitride, boron nitride, silicon nitride, diamond, graphite, carbon nanotubes, silicon metal, carbon fiber, fullerene, and so forth, in a silicone polymer.

The impact mitigation member 40 that is made of the dilatant material is disposed only between the lower face of the battery pack 20 and the share panel 30. In other words, the impact mitigation member 40 is not disposed on an upper face side or side face sides of the battery pack 20.

The share panel 30 may be made of iron, but is, as one example, made of fiber-reinforced plastic. The share panel 30 includes a share panel main portion 31, and a share panel reinforcing member that is omitted from illustration. The impact mitigation member 40 fills a gap between the share panel main portion 31 and the lower face of the battery pack 20, with no space remaining therebetween.

However, the impact mitigation member 40 may be spaced apart from the share panel main portion 31, in a state of being joined to the lower face of the battery pack 20. On the other hand, the impact mitigation member 40 may be spaced apart from the lower face of the battery pack 20, in a state of being joined to the share panel 30.

### Modifications

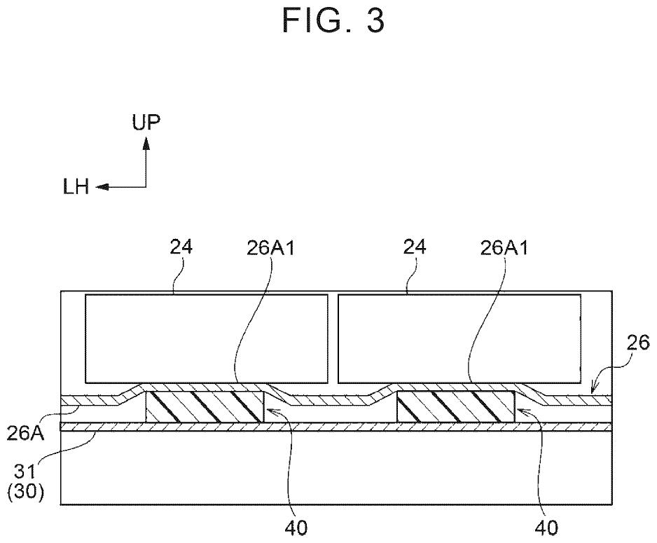

FIG. 3 is a cross-sectional view according to a modification.

As illustrated in FIG. 3, in this modification, the impact mitigation member 40 is partially provided corresponding to portions of the bottom plate portion 26A at which the bulging portions 26A1 are located. Specifically, in this modification, the impact mitigation member 40 is divided into a plurality of parts in the vehicle width direction. No members that are made of dilatant material are disposed between the impact mitigation members 40.

### Functions and Effects

Next, functions and effects of the present embodiment will be described.

In the present embodiment, the vehicle underfloor structure S includes the battery pack 20 that is installed underfloor in the vehicle, and the share panel 30 is disposed on the lower side of the battery pack 20.

Accordingly, the share panel 30 can protect the battery pack 20 from fallen objects lying on the road, speed bumps, bottoming-out roads, and the like.

However, in order to adequately protect the battery pack 20, there is a problem of increased weight, increased costs, and so forth, with respect to the share panel 30. Furthermore, in order to adequately absorb impact energy, providing an up-down direction gap (impact absorbing stroke) between the battery pack 20 and the share panel 30 is necessary.

Accordingly, in the present embodiment, the vehicle underfloor structure S further includes the impact mitigation member 40 that is made of the dilatant material and that is disposed between the lower face of the battery pack 20 and the share panel 30.
Thus, the impact mitigation member 40 that is made of the dilatant material functions to protect the battery pack 20 from underfloor impact. In particular, dilatant materials have a nature of becoming hard when subjected to a great input, and accordingly a small impact absorbing stroke is sufficient. As a result, occurrence of the above problems and so forth regarding the share panel 30 can be suppressed.

Further, in the present embodiment, the impact mitigation member 40 that is made of the dilatant material is disposed only between the lower face of the battery pack 20 and the share panel 30. That is to say, the impact mitigation member 40 is not disposed on the top face side or the side face sides of the battery pack 20, at which possibility of contact with a fallen object or the like is low.

Accordingly, increase in costs caused by providing the impact mitigation member 40 that is made of the dilatant material can be suppressed. Also, the weight of the share panel 30 can be reduced.

Also, in the present embodiment, the share panel 30 is made of fiber-reinforced plastic.

Accordingly, reduction in weight of the structure is easier as compared to a form in which the share panel 30 is made of iron. The share panel 30 that is made of fiber-reinforced plastic has high functionality of suppressing penetration by sharp foreign objects, but does not absorb impact well. However, absorption of impact can be borne by the impact mitigation member 40 that is made of the dilatant material.

Also, in the present embodiment, the share panel 30 includes the share panel main portion 31. The impact mitigation member 40 fills in the gap between the share panel main portion 31 and the lower face of the battery pack 20, with no space remaining therebetween. Accordingly, the battery pack 20 can be protected more effectively. Also, the structure can be made smaller in size in the up-down direction of the vehicle, as compared to a case in which the aforementioned gap is provided. As a result, for example, battery capacity can be increased and a vehicle cabin can be made to be wider.

Also, in the present embodiment, the battery pack 20 includes the lower case 26 having the bottom plate portion 26A, and the bottom plate portion 26A has the bulging portions 26A1 that partially bulge upward.

Accordingly, rigidity of the bottom plate portion 26A can be improved.
Also, in the present embodiment, the impact mitigation member 40 is partially provided corresponding to portions at which the bulging portions 26A1 are located in the bottom plate portion 26A.
Accordingly, the amount of the impact mitigation member 40 that is made of the dilatant material used can be reduced, while securing protection of the battery pack 20.

Also, in the present embodiment, the impact mitigation member 40 may be integrated with the battery pack 20 or the share panel 30.

In this case, the impact mitigation member 40 can be handled integrally with either the battery pack 20 or the share panel 30 during a vehicle assembly process. For example, the impact mitigation member 40 may be joined to the share panel 30 by an adhesive or the like. In this case, the impact mitigation member 40 does not have to be joined to the battery pack 20.

Although a preferred embodiment of the present disclosure has been described above, the present disclosure is not limited to the above description.

What is claimed is:

1. A vehicle underfloor structure, comprising:
a battery pack that is installed underfloor in a vehicle;
a share panel that is disposed on a lower side of the battery pack; and
an impact mitigation member that is made of a dilatant material and that is disposed only between a lower face of the battery pack and the share panel.

2. The vehicle underfloor structure according to claim 1, wherein the share panel is made of fiber-reinforced plastic.

3. The vehicle underfloor structure according to claim 1, wherein:
the share panel includes a share panel main portion; and
the impact mitigation member fills a gap between the share panel main portion and the lower face of the battery pack with no space remaining between the share panel main portion and the lower face.

4. The vehicle underfloor structure according to claim 1, wherein:
the battery pack includes a lower case with a bottom plate portion;
the bottom plate portion includes a bulging portion that partially bulges upward; and
the impact mitigation member is partially provided corresponding with a portion of the bottom plate portion at which the bulging portion is situated.

5. The vehicle underfloor structure according to claim 1, wherein the impact mitigation member is integrated with the battery pack or the share panel.
